(19) United States
(12) Patent Application Publication
(10) Pub. No.: US 2005/0088989 A1
(43) Pub. Date: Apr. 28, 2005

(54) Methods of transmitting data in mobile communication system

(75) Inventors: Jae Ho Lee, Changwon-Si (KR); Yeoun Joo Choi, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CURITEL COMMUNICATIONS, INC.

(21) Appl. No.: 10/976,096

(22) Filed: Oct. 27, 2004

(30) Foreign Application Priority Data
Oct. 28, 2003 (KR) 10-2003-0075434

(51) Int. Cl. H04Q 7/00

(52) U.S. Cl. 370/328

(57) ABSTRACT

The present invention relates to methods of transmitting data in a mobile communication system. More specifically, the present invention relates to methods of transmitting data in a mobile communication system that may improve a data transmission speed in a mobile communication system using a network storage space of the mobile communication system. According to the present invention, it is made possible to achieve an improvement of data transmission speed and an effective data control by separating the data flow between a mobile communication terminal and wired communication network into i) data flow between wired communication network and mobile communication network and ii) data flow between the mobile communication network and the mobile communication terminal through using a network storage space acting as a relay node.

### CROSS-REFERENCE TO RELATED APPLICATION

The entire disclosure of Korean Patent Application No. 10-2003-0075434 filed on Oct. 28, 2003 including specification, claims, drawings and summary, is incorporated herein by reference in its entirety.

### BACKGROUND OF THE INVENTION

1. Field of the Invention

The present invention relates to methods of transmitting data in a mobile communication system. More specifically, the present invention relates to methods of transmitting data in a mobile communication system that may improve a data transmission speed in the mobile communication system using a network storage space of the mobile communication system.

2. Description of the Related Art

Recently, mobile communication field is shifting from circuit connection type mainly for voices to a packet transmission type transmitting multimedia data including pictures, moving images as well as voices. Therefore, contents providers (CP) providing a variety of different multimedia services come up and a wireless data transmission method is evolving to improve data transmission speed and quality for fulfillment of user's needs on such multimedia services.

For using a conventional multimedia service, a user establishes a connection with a server of contents provider through network of relevant contents provider using internet transmission protocol (e.g. Transmission Control Protocol (TCP) or User Datagram Protocol (UDP), etc.) and selects a preferred multimedia service. Thereafter, the selected multimedia data is transmitted to the user's mobile communication terminal.

Herein, a flow control and an error control are executed through end-to-end connection control in a conventional internet transmission protocol. Since wireless communication environment is relatively inferior to wired communication environment, the data rate and quality are determined in accordance with the environment for wireless communication.

Moreover, since the conventional internet transmission protocol makes user access to a wireless communication service provider through wireless communication environment and access to a wired service provider through internet network, the time required for downloading services is increasingly delayed due to complicated flow control and error control.

Therefore, it is very difficult to provide service for transmitting large-sized data and real-time streaming data in accordance with user's needs. When a data connection is dropped due to errors made during downloading process, the user has to re-establish a connection and then receive the service again, which causes much trouble to the user. And, in the prior art, if a user deletes previously received data from the user's mobile communication terminal, the user should perform same process to download same data again after re-payment.

The prior art has asymmetric structure assigning more wireless resources to the downlink transmission (from a communication network to a user) rather than uplink transmission (from a user to a communication network), so that it has a problem of unbalance in provided service.

As described above, the method of transmitting data in mobile communication system according to the prior art has problem in that re-connection and re-transmission are increased due to i) drawbacks of wireless communication environment of mobile communication terminal supporting multimedia data transmission using a circuit connection and ii) complicated paths to wired service provider in wired communication network. Such problem inevitably results in a reduced data rate, an increased load, a reduced bandwidth and so on.

### BRIEF SUMMARY OF THE INVENTION

Accordingly, the present invention has been made to solve the above-mentioned problems occurring in the related art.

It is an object of the present invention to provide a method of transmitting data in a mobile communication system to improve the data transmission speed using a network storage space in a mobile communication system, in order to overcome the foregoing problems of the prior art.

It is a further object of the present invention to achieve an improvement of data transmission speed and an effective data control by separating the data flow between a mobile communication terminal and wired communication network into i) data flow between wired communication network and mobile communication network and ii) data flow between the mobile communication network and the mobile communication terminal through using a network storage space acting as a relay node.

It is a further object of the present invention to improve the performance of data flow both in wired communication environment and wireless communication environment and to achieve more effective wireless resource utilization and reduction of network load in various multimedia services using packet data.

In fulfillment of the objectives described above, the present invention provides a method of transmitting data in a mobile communication system, comprising acts of: transmitting data from a service provider server to a network storage space of a data connection server and storing the data in the network storage space, the service provider server being wirelessly connected to a mobile communication terminal through the data connection server; and transmitting the data stored in the network storage space to the mobile communication terminal.

Preferably, the data is stored in the network storage space first as a temporary file and change in the temporary file is transmitted to the mobile communication terminal, in case that the data is real-time data.

Preferably, the mobile communication terminal performs other works, while the data is transmitted from the service provider server to the network storage space and stored in the network storage space.

Preferably, the act of transmitting data from a service provider server to a network storage space of a data connection server and storing the data in the network storage space comprises acts of: selecting data to be transmitted at the service provider server; determining whether there is data in the network storage space identical with the selected data; and in case that there is no data identical with the selected data in the network storage space, transmitting the selected data from the service provider server and storing the selected data in the network storage space.

Preferably, the act of transmitting the selected data from the service provider server and storing the selected data in the network storage space further comprises act of: notifying the mobile communication terminal of completion of data transmission and storage, after transmitting the data to the network storage space and storing the data in the network storage space.

Preferably, the act of transmitting data from a service provider server to a network storage space of a data connection server and storing the data in the network storage space comprises act of: authenticating user of the mobile communication terminal accessing to the data connection server.

Preferably, the act of transmitting data from a service provider server to a network storage space of a data connection server and storing the data in the network storage space, comprises acts of: selecting data to be transmitted at the service provider server; determining whether there is data in the network storage space identical with the selected data; in case that there is data in the network storage space identical with the selected data, determining whether or not the data has been completely transmitted from the service provider server; and in case that the data has not been completely transmitted from the service provider server, receiving from the service provider server parts of the data which has not been transmitted and storing the data including the parts in the network storage space.

Preferably, the act of transmitting data from a service provider server to a network storage space of a data connection server and storing the data in the network storage space, further comprises act of: notifying the mobile communication terminal of completion of data transmission and storage, after transmitting the parts of the data which has not been transmitted to the network storage space and storing the data including the parts in the network storage space.

Preferably, the act of transmitting data from a service provider server to a network storage space of a data connection server and storing the data in the network storage space comprises acts of: selecting data to be transmitted at the service provider server; determining whether there is data in the network storage space identical with the selected data; in case that there is data in the network storage space identical with the selected data, determining whether or not the data has been completely transmitted from the service provider server; and in case that the data has been completely transmitted from the service provider server, notifying the mobile communication terminal of existence of data identical with the selected data.

Preferably, the act of transmitting the data stored in the network storage space to the mobile communication terminal comprises acts of: selecting data to be transmitted at the network storage space; determining whether or not the selected data has been completely transmitted to the network storage space; and in case that the selected data has been completely transmitted to the network storage space, transmitting the data from the network storage space to the mobile communication terminal.

Preferably, the act of transmitting the data stored in the network storage space to the mobile communication terminal comprises act of: notifying the mobile communication terminal of whether the data in the network storage space has been completely transmitted to the network storage space or not.

Preferably, the act of selecting data to be transmitted at the network storage space comprises acts of: transmitting list of data stored in the network storage space to the mobile communication terminal; and notifying the data connection server of selection of data.

Preferably, the act of transmitting the data stored in the network storage space to the mobile communication terminal comprises acts of: selecting data to be transmitted at the network storage space; determining whether or not the selected data has been completely transmitted to the network storage space; in case that the selected data has not been completely transmitted to the network storage space, receiving from the service provider server parts of the data which has not been transmitted to the network storage space and storing the parts of the data in the network storage space; and transmitting the data from the network storage space to the mobile communication terminal.

Preferably, the act of transmitting the data stored in the network storage space to the mobile communication terminal further comprises act of: in case that the selected data has not been completely transmitted to the network storage space, asking the mobile communication terminal whether to receive the data from the service provider server after re-accessing to the service provider server.

Preferably, the act of transmitting the data stored in the network storage space to the mobile communication terminal further comprises act of: in case of deciding not to receive the data from the service provider server after re-accessing to the service provider server, deleting the data stored in the network storage space.

Preferably, the act of transmitting the data stored in the network storage space to the mobile communication terminal comprises act of: deciding whether to delete the data in the network storage space after transmitting the data to the mobile communication terminal, and performing a result of the decision.

Differently, there is provided another method of transmitting data in a mobile communication system comprising acts of: transmitting list of data which are provided by service provider server from the service provider server to data connection server and storing the list of data in the data connection server; and transmitting the data among the list of data from the service provider server to the mobile communication terminal.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a configuration of system for transmitting data according to a preferred embodiment of the present invention;

FIG. 2 is a flow chart showing a method of transmitting data in a mobile communication system according to a preferred embodiment of the present invention;

FIG. 3 is a flow chart showing a process of transmitting data to network storage space and storing the data in the network storage space of FIG. 2; and

FIG. 4 is a flow chart showing a process of transmitting data to mobile communication terminal and managing the data in network storage space of FIG. 3.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

In accordance with the present invention, a process of transmitting data is classified into i) transmitting data from wired communication network to mobile communication network and ii) transmitting data from the mobile communication network to mobile communication terminal, so that the existing platform or system can be utilized without any alteration by just adding software for transmitting and controlling data.

Differently, it is made possible to remove necessity of introducing extra system by using storage space provided in conventional multimedia service as a data storage space.

The exemplary embodiments of the present invention are described in detail with reference to the attached drawings in the following.

In order to avoid direct data transmission between users and service provider server having complicated paths, and overcome problems of transmission time increase and re-transmission caused by poor wireless communication environments and errors, data is transmitted from the service provider server to network storage space of the mobile communication network and stored first in the network storage space, according to the present invention. In other words, by transmitting data from the service provider server to network storage space of the mobile communication network, having better environments and data rate, corresponding to user account, and allowing the user to receive the data from the network storage space of the mobile communication network at any time when the user wants, it is possible to receive the data without additional payment.

And, a method of transmitting data in a mobile communication system according to an exemplary embodiment of the present invention has data server (i.e. network storage space) having relatively high speed in a mobile communication system acting as a temporary buffer storing temporary data in case of real-time multimedia data, so that it is made possible to transmit the data to the user (mobile communication terminal) through the mobile communication network. Thus, it is made possible to effectively receive multimedia service including multimedia broadcasting, movie, etc. with existing platform or system, to reduce data transmission and reception time by simplifying complex data transmission paths and to improve performance of total system by improving load of wireless resource (e.g. reduction of data channel occupancy).

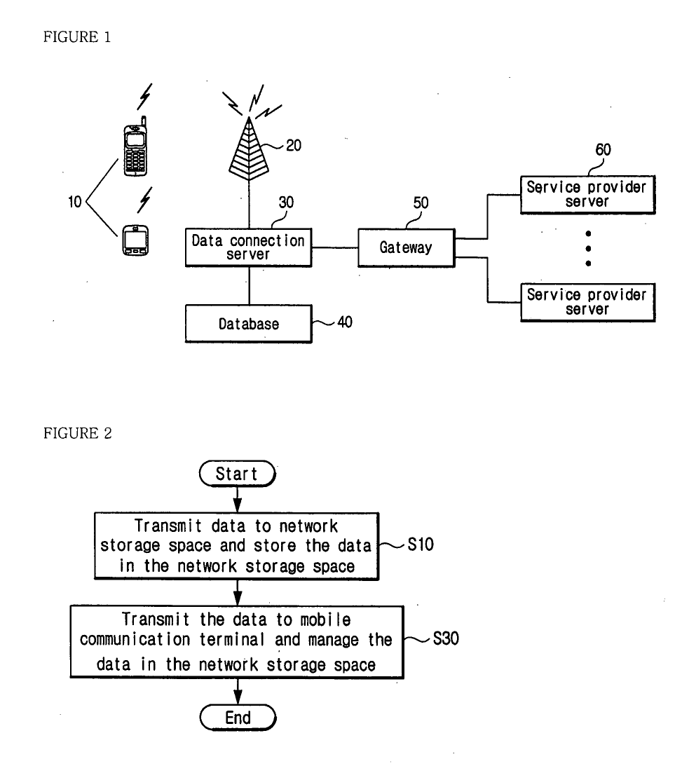

As shown in FIG. 1, mobile communication system according to a preferred embodiment of the present invention comprises a mobile communication terminal 10 supporting a packet data transmission, a base station 20, a data connection server 30, a database 40, a gateway 50 executing a connection with external network such as internet network, etc., and a plurality of service provider servers 60.

The mobile communication terminal 10 receives data temporarily stored in the database 40 through the data connection server 30 and the base station 20 in real time or non-real time.

The data connection server 30 could be either a server performing a direct data transmission with the mobile communication terminal 10 (e.g. public switched data network or proxy server) or a server, connected to the server performing a direct data transmission, controlling and supporting the various services. And, the data connection server 30 has a space acting as a buffer to improve transmission speed and efficiency of multimedia data in both uplink and downlink transmissions. That is, the data connection server 30 manages database 40, a network storage space, assigned to individual users and has the database 40 temporarily store transmitted data in the database 40.

The database 40, which is a buffer space acting as a relay, means a space in a network for individual users to store data, such as a Multimedia Messaging System (MMS) server currently in service. That is, when the mobile communication terminal 10 receives the relevant data from service provider servers 60, or transmits data to other mobile communication terminals or clients, the mobile communication terminal is asked to decide whether to use own assigned network storage space. According to the decision on whether to use own assigned network storage space, the data connection server could provide different data transmission service.

First, if the network storage space is not used, it proceeds with conventional data transmission service as described above.

Second, if the network storage space is used, the data connection server 30 has the network storage space store the data therein when the data is transmitted to the data connection server 30. And, when the data is completely stored in the appropriate network storage space, the message notifying the completion of the data transmission is generated and transmitted to the mobile communication terminal 10, whereby the user can freely download the stored data or transmit them to other clients, after accessing to the network storage space.

Here, if the data is streaming data, the data is primarily stored in the network storage space as a temporary file, and in turn only the changed part of the relevant temporary file is transmitted to the user in real time. Therefore, the optimum transmission speed available in wired communication network is achieved between the service provider server 60 and the data connection server 30 including the network storage space, and the data transmission speed between the mobile communication terminal 10 and the network storage space reaches to the secured level in a mobile communication network. Accordingly, the fast streaming service can be provided.

In contrast to the prior art, where the mobile communication terminal cannot do any other works during data transmission, multiple working environments are implemented according to the present.

That is, the mobile communication terminal 10 can respectively do other works while data is transmitted to the network storage space, by making wired service server (e.g. service provider server) transmit data to/from mobile communication network (e.g. network storage space).

Moreover, since there is no actual data transmission made in the mobile communication terminal 10 until transmission completion message is delivered, the un-necessary payment for data transmission can be prevented. Without the undesirable time delay and payment caused by the inferior condition of mobile communication network, the data is primarily stored in the network storage space and transmitted to the mobile communication terminal by re-accessing to the network storage space when condition of connection becomes better.

And, data transmission completion message can be transmitted through a Short Message Service (SMS) or a multimedia message system such as a MMS.

Data once stored in the network storage space can be maintained in the network storage space without regard to environments of storage space of the mobile communication terminal 10. Thereby, the user can download the relevant data at any time and share the data with other clients. In other words, the data stored in the network storage space can be transmitted to the mobile communication terminal at any time and transmitted from the mobile communication terminal to other mobile communication terminal. Since the transmitted data is stored in the network storage space without regard to the mobile communication terminal 10 (that is, the data flow between a mobile communication network and a wired service server is controlled without regard to the condition of the mobile communication terminal 10), management of data becomes easier.

In another exemplary embodiment, only data list (e.g. multimedia list) is stored in the data connection server 30 instead of real network storage space, and the data can be directly received from the respective service provider servers 60 via the data connection server 30 and the gateway 50 later when downloading the data. Here, beginning moment of payment for data download is set to the moment of selecting relevant data or requesting data download.

Hereinafter, a method of transmitting data in a mobile communication system according to the preferred embodiment of the present invention will be briefly described with reference to the flow chart of FIG. 2.

Data selected by the user is transmitted from the service provider server 60 to the network storage space through the data connection server 30 and the gateway 50, and is stored in the network storage space (S10), and the data is transmitted to the mobile communication terminal accessing to the network storage space or managed by the user of the mobile communication terminal (S30).

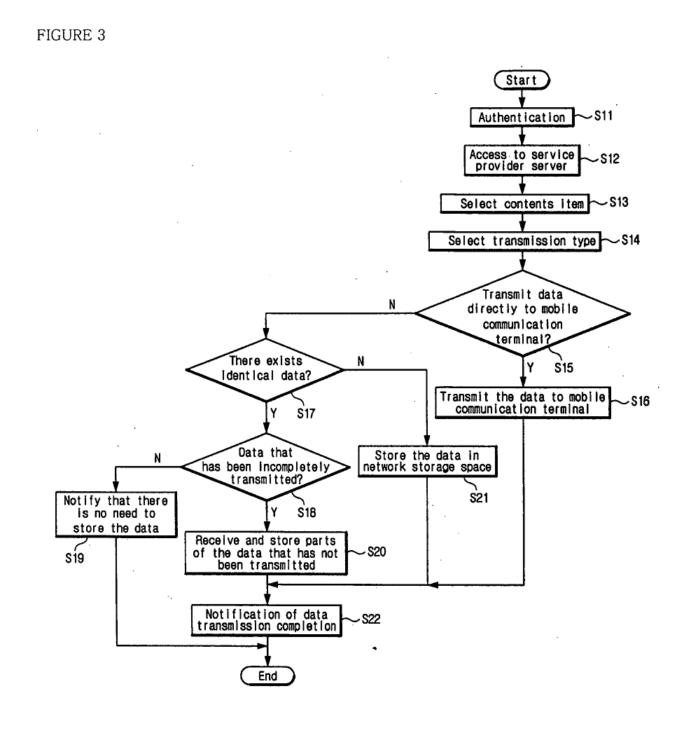

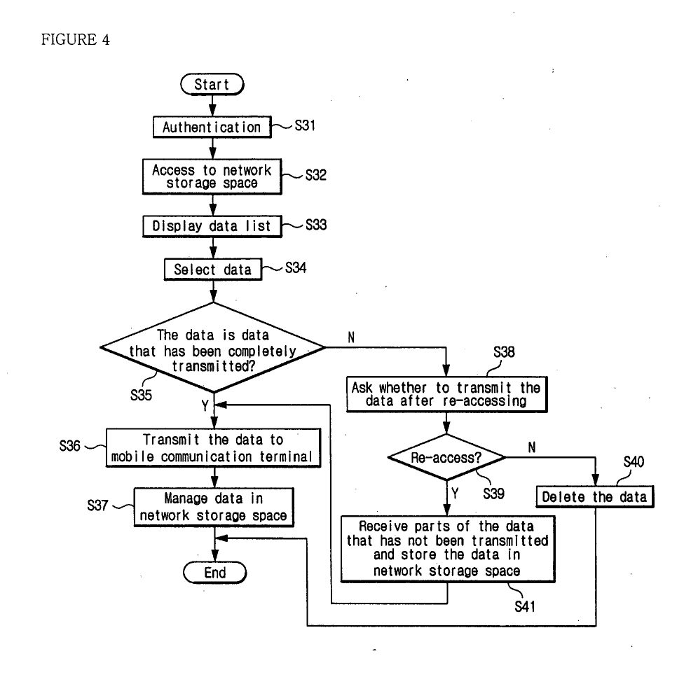

First, a first act of storing data will be described in detail with reference to the flowchart of FIG. 3.

The mobile communication terminal primarily accesses to the data connection server through wireless communication environments and goes through a series of processes such as authentication process for data transmission (S11), and then accesses to the service provider server 60 (S12).

Then, when a user selects item of contents from the service provider servers for downloading, the data connection server detects the selection of the relevant contents item (S13), and then whether to transmit the data corresponding to the items of contents to the user directly or to the network storage space of the data connection server 30 is decided (S14). The decision on whether to transmit the data directly to the mobile communication terminal is determined (S15).

At the step S15, in case that direct data transmission to the mobile communication terminal 10 is decided, the data connection server 30 receives the data corresponding to the selected contents item from the respective service provider servers 60 and transmits the data to the mobile communication terminal 10 (S16).

But, if the data is stored in the network storage space at the step S15, the data connection server 30 has the network storage space store the data corresponding to the selected contents item therein with displaying whether there is data identical with the selected data in the network storage space or whether the data stored in the network storage space is data which has not been completely transmitted to the network storage space. In case that the data is new data or data that has never been transmitted, the selected data is transmitted to the network storage space and stored in the network storage space.

Namely, whether there is data identical with the data corresponding to the selected contents item in the network storage space (S17).

When the identical data exists (S17), whether the data has been completely transmitted is determined (S18). In case that the identical data is the data which has been completely transmitted (S18), the identical data were normally stored in the network storage space, thereby notifying the user that there is no need to re-store the relevant data (S19).

And, when the identical data is data that has been incompletely transmitted (S18), only parts of the data that has not been transmitted are transmitted to the network storage space and stored in the network storage space (S20). If establishment of connection with the service provider server 60 is failed, messages of re-trial, deletion or cancellation are displayed in the mobile communication terminal to let the user decide.

If there is no identical data (that is, the data is new data) (S17), the new data is transmitted from the service provider server 60 and stored in the network storage space (S21).

Then, the data connection server 30 transmits data transmission completion message to the mobile communication terminal 10 to notify the user of data transmission completion through message services (e.g. SMS or MMS) (S22).

Second, the second act (S30) of data transmission and management process will be described in detail with reference to the flowchart of FIG. 3.

The mobile communication terminal primarily accesses to the data connection server 30 through wireless communication environments, and then a series of processes such as authentication are processed (S31). The user authenticated by using identification and password can access to the network storage space through packet channel at any time (S32). That is, the mobile communication terminal can access to the network storage space at any time after the user thereof is authenticated.

And, the data connection server 30 transmits the data lists stored in the network storage space to the mobile communication terminal and the user of the mobile communication terminal can see the data lists (S33). If the user selects data among the data lists (S34), the data connection server 30 determines whether the data is data that has been completely transmitted and stored or not (S36). Simultaneously, whether the data is data that has been completely transmitted and stored or not is displayed through the mobile communication terminal.

If the selected data is data that has been completely transmitted and stored, the data connection server 30 reads the data from the network storage space and transmits the data to the mobile communication terminal 10 (S37). Then, after completing data transmission, whether the data will be removed from the network storage space is asked to the user (the mobile communication terminal) for data management (S38).

On the other hand, if the selected data is data that has been incompletely transmitted to the network storage space, the data connection server 30 asks the user whether to transmit the selected data to the mobile communication terminal after re-accessing to the service provider server and receiving parts of data that has not been transmitted (S39). Then, what the user selects between cancellation and re-access is determined (S40).

In the case of the choice of cancellation, the data connection server deletes the selected data from the network storage space (S41). Herein, the selected data is data that has been incompletely transmitted to the network storage space.

On the other hand, in the case of the choice of re-access, the data connection server establishes a connection with the service provider server 60, and then receives parts of the data that has not been transmitted from the service provider server and stores the data in the network storage space (S42). Afterward, steps after the step S37 in the flowchart are undertaken.

Here, if establishing a connection with the service provider server 60 is failed, notification message of re-trial, deletion or cancellation is displayed at the mobile communication terminal 10 to let the user decide.

As described above, a method of transmitting data in a mobile communication system according to the present invention separate data flow between wired communication network and mobile communication terminal into i) wired communication network and mobile communication network and ii) the mobile communication network and mobile communication terminal by using network storage space in mobile communication network, thereby simplifying complex transmission paths. Further, the method of transmitting data in a mobile communication system stores data received through data transmission between wired communication network and mobile communication network having high transmission speed and stability first and transmits the data to the mobile communication terminal, so that it is made possible to solve problems of transmission time increase and re-transmission caused by poor wireless communication environments, thereby improving wireless data transmission speed.

Since the disconnection in the midst of data transmission can frequently happen in a wireless environment having restrictive resources and a lot of limitations compared to a wired communication environment, re-establishment of a connection with a wired service provider server should be needed in the prior art. However, since data transmission between the network storage space and the service provider server is executed without regard to condition of the mobile communication terminal in the present invention, the mobile communication terminal can download the selected data any time through simply establishing a connection with the network storage space at a later time.

Since the transmitted data is stored in the independent space without regard to the condition of the mobile communication terminal, there is no need to compete for data transmission in the inferior state of wireless resources and the data download can be executed when the wireless environment is recovered.

Although, in the prior art, the mobile communication terminal cannot do any other works until data transmission with a wired service provider is completed, the mobile communication terminal of the present invention can do other works while data is transmitted between the wired service provider and the network storage space, simply by disconnecting with a mobile communication network for a moment and accessing to the network storage space later.

The method of transmitting data according to the present invention can be utilized with conventional multimedia services, since the completion of data transmission can be notified using a messaging system such as MMS.

While the present invention has been shown and described with reference to certain preferred embodiments thereof, it will be understood by those skilled in the art that various changes in form and details may be made therein without departing from the spirit and scope of the invention as defined by the appended claims.

1. A method of transmitting data in a mobile communication system, comprising acts of:
transmitting data from a service provider server to a network storage space of a data connection server and storing the data in the network storage space, the service provider server being wirelessly connected to a mobile communication terminal through the data connection server; and
transmitting the data stored in the network storage space to the mobile communication terminal.

2. The method of transmitting data in a mobile communication system according to claim 1, wherein the data is stored in the network storage space first as a temporary file and change in the temporary file is transmitted to the mobile communication terminal, in case that the data is real-time data.

3. The method of transmitting data in a mobile communication system according to claim 1, wherein the mobile communication terminal performs other works, while the data is transmitted from the service provider server to the network storage space and stored in the network storage space.

4. The method of transmitting data in a mobile communication system according to claim 1, wherein the act of transmitting data from a service provider server to a network storage space of a data connection server and storing the data in the network storage space comprises acts of:
selecting data to be transmitted at the service provider server;
determining whether there is data in the network storage space identical with the selected data; and
in case that there is no data identical with the selected data in the network storage space, transmitting the selected data from the service provider server and storing the selected data in the network storage space.

5. The method of transmitting data in a mobile communication system according to claim 4, wherein the act of transmitting the selected data from the service provider server and storing the selected data in the network storage space further comprises act of:
notifying the mobile communication terminal of completion of data transmission and storage, after transmitting the data to the network storage space and storing the data in the network storage space.

6. The method of transmitting data in a mobile communication system according to claim 1, wherein the act of transmitting data from a service provider server to a network storage space of a data connection server and storing the data in the network storage space comprises act of:
authenticating user of the mobile communication terminal accessing to the data connection server.

7. The method of transmitting data in a mobile communication system according to claim 1, wherein the act of transmitting data from a service provider server to a network storage space of a data connection server and storing the data in the network storage space, comprises acts of:
selecting data to be transmitted at the service provider server;
determining whether there is data in the network storage space identical with the selected data;
in case that there is data in the network storage space identical with the selected data, determining whether or not the data has been completely transmitted from the service provider server; and
in case that the data has not been completely transmitted from the service provider server, receiving from the service provider server parts of the data which has not been transmitted and storing the data including the parts in the network storage space.

8. The method of transmitting data in a mobile communication system according to claim 7, wherein the act of transmitting data from a service provider server to a network storage space of a data connection server and storing the data in the network storage space, further comprises act of:
notifying the mobile communication terminal of completion of data transmission and storage, after transmitting the parts of the data which has not been transmitted to the network storage space and storing the data including the parts in the network storage space.

9. The method of transmitting data in a mobile communication system according to claim 1, wherein the act of transmitting data from a service provider server to a network storage space of a data connection server and storing the data in the network storage space comprises acts of:
selecting data to be transmitted at the service provider server;
determining whether there is data in the network storage space identical with the selected data;
in case that there is data in the network storage space identical with the selected data, determining whether or not the data has been completely transmitted from the service provider server; and
in case that the data has been completely transmitted from the service provider server, notifying the mobile communication terminal of existence of data identical with the selected data.

10. The method of transmitting data in a mobile communication system according to claim 1, wherein the act of transmitting the data stored in the network storage space to the mobile communication terminal comprises acts of:
selecting data to be transmitted at the network storage space;
determining whether or not the selected data has been completely transmitted to the network storage space; and
in case that the selected data has been completely transmitted to the network storage space, transmitting the data from the network storage space to the mobile communication terminal.

11. The method of transmitting data in a mobile communication system according to claim 1, wherein the act of transmitting the data stored in the network storage space to the mobile communication terminal comprises act of:
notifying the mobile communication terminal of whether the data in the network storage space has been completely transmitted to the network storage space or not.

12. The method of transmitting data in a mobile communication system according to claim 10, wherein the act of selecting data to be transmitted at the network storage space comprises acts of:
transmitting list of data stored in the network storage space to the mobile communication terminal; and
notifying the data connection server of selection of data.

13. The method of transmitting data in a mobile communication system according to claim 1, wherein the act of transmitting the data stored in the network storage space to the mobile communication terminal comprises acts of:
selecting data to be transmitted at the network storage space;
determining whether or not the selected data has been completely transmitted to the network storage space;
in case that the selected data has not been completely transmitted to the network storage space, receiving from the service provider server parts of the data which has not been transmitted to the network storage space and storing the parts of the data in the network storage space; and
transmitting the data from the network storage space to the mobile communication terminal.

14. The method of transmitting data in a mobile communication system according to claim 13, wherein the act of transmitting the data stored in the network storage space to the mobile communication terminal further comprises act of:
in case that the selected data has not been completely transmitted to the network storage space, asking the mobile communication terminal whether to receive the data from the service provider server after re-accessing to the service provider server.

15. The method of transmitting data in a mobile communication system according to claim 14, wherein the act of transmitting the data stored in the network storage space to the mobile communication terminal further comprises act of:
in case of deciding not to receive the data from the service provider server after re-accessing to the service provider server, deleting the data stored in the network storage space.

16. The method of transmitting data in a mobile communication system according to claim 1, wherein the act of transmitting the data stored in the network storage space to the mobile communication terminal comprises act of:
deciding whether to delete the data in the network storage space after transmitting the data to the mobile communication terminal, and performing a result of the decision.

17. A method of transmitting data in a mobile communication system comprising acts of:
transmitting list of data which are provided by service provider server from the service provider server to data connection server and storing the list of data in the data connection server; and
transmitting the data among the list of data from the service provider server to the mobile communication terminal.
